(19) United States
(12) Patent Application Publication
(10) Pub. No.: US 2013/0094779 A1
(43) Pub. Date: Apr. 18, 2013

(54) Method and Apparatus for Prediction Unit Size Dependent Motion Compensation Filtering Order

(71) Applicant: TEXAS INSTRUMENTS INCORPORATED, Dallas, TX (US)

(72) Inventors: Madhukar Budagavi, Plano, TX (US); Ranga Ramanujam Srinivasan, Villupuram (IN)

(73) Assignee: TEXAS INSTRUMENTS INCORPORATED, Dallas, TX (US)

(21) Appl. No.: 13/644,800

(22) Filed: Oct. 4, 2012

Related U.S. Application Data
(60) Provisional application No. 61/559,948, filed on Nov. 15, 2011.
(60) Provisional application No. 61/543,168, filed on Oct. 4, 2011.

(51) Int. Cl. G06T 5/00

(52) U.S. Cl. CPC G06T 5/002
USPC 382/260

(57) ABSTRACT

A motion compensation method and apparatus. The method includes retrieving data relating to a reference bock, performing a transpose on the retrieved data, performing vertical filtering on the transposed retrieved data, performing one or more transpose on the vertically filtered data, performing horizontal filtering on the transposed vertically filtered dad, and generating an interpolated bock and storing the interpolated block.

### CROSS-REFERENCE TO RELATED APPLICATIONS

This application claims benefit of U.S. provisional patent application Ser. No. 61/559,948, filed Oct. 15, 2011, and 61/543,168, filed Oct. 4, 2011, which are herein incorporated by reference.

### BACKGROUND OF THE INVENTION

1. Field of the Invention

Embodiments of the present invention generally relate to a method and apparatus for prediction unit size dependent motion compensation filtering order.

2. Description of the Related Art

The motion compensation order is fixed for all prediction unit block sizes in HM 4.0 for high efficiency setting. Horizontal filtering is carried out first and the output of the horizontal filtering is rounded to fit within 16 bits. The rounded output from the first stage is then vertically filtered.

FIG. 1 is an embodiment of a motion compensation apparatus. As shown in FIG. 1, Transpose 1 and Transpose 2 are used for row access from input memory and row access to output memory. Transpose 1 reads in row at a time and writes out column at a time. Transpose 2 reads in column at a time and writes out row at a time. Several multiplexers are used to bypass different blocks for special cases of filtering, such as, H subpel, V subpel, Integer pel, etc.

Table 1 lists the number of motion compensation operations when the motion compensation filtering order is fixed and modified depending on the prediction unit (PU) size. In Table 1, motion vectors are assumed to be fractional in both x- and y-directions. As shown in Table 1, motion compensation computation cycle reduction is in the range from 5% for 64×32 block to 35% for 16×4 block. At time, such as in High Efficiency Video Coding (HEVC), the system may not support 4×4 PU. Hence, 8×4 PU becomes worst case block size from motion compensation cycles point of view.

TABLE 1
Comparison of MC cycles for fixed MC filtering order and PU size dependent MC filtering
order. Motion vectors are assumed to be fractional in both x- and y-directions

| Block | Block | Fixed MC filter order | | | PU size dependent MC filter order | | | Percent |
|---|---|---|---|---|---|---|---|---|
| width | height | Filtering | Num MC | Num MC | Filtering | Num MC | Num MC | savings in |
| (w) | (h) | order | filterings | filterings | order | filterings | filterings | computations |
| 8 | 4 | H first | (h + 7)*w + w*h | 120 | V first | (w + 7)*h + w*h | 92 | 23% |
| 16 | 4 | H first | (h + 7)*w + w*h | 240 | V first | (w + 7)*h + w*h | 156 | 35% |
| 16 | 8 | H first | (h + 7)*w + w*h | 368 | V first | (w + 7)*h + w*h | 312 | 15% |
| 32 | 8 | H first | (h + 7)*w + w*h | 736 | V first | (w + 7)*h + w*h | 568 | 23% |
| 32 | 16 | H first | (h + 7)*w + w*h | 1248 | V first | (w + 7)*h + w*h | 1136 | 9% |
| 64 | 16 | H first | (h + 7)*w + w*h | 2496 | V first | (w + 7)*h + w*h | 2160 | 13% |
| 64 | 32 | H first | (h + 7)*w + w*h | 4544 | V first | (w + 7)*h + w*h | 4320 | 5% |
| 4 | 8 | H first | (h + 7)*w + w*h | 92 | H first | (h + 7)*w + w*h | 92 | 0% |
| 4 | 16 | H first | (h + 7)*w + w*h | 156 | H first | (h + 7)*w + w*h | 156 | 0% |
| 8 | 16 | H first | (h + 7)*w + w*h | 312 | H first | (h + 7)*w + w*h | 312 | 0% |
| 8 | 32 | H first | (h + 7)*w + w*h | 568 | H first | (h + 7)*w + w*h | 568 | 0% |
| 16 | 32 | H first | (h + 7)*w + w*h | 1136 | H first | (h + 7)*w + w*h | 1136 | 0% |
| 16 | 64 | H first | (h + 7)*w + w*h | 2160 | H first | (h + 7)*w + w*h | 2160 | 0% |
| 32 | 64 | H first | (h + 7)*w + w*h | 4320 | H first | (h + 7)*w + w*h | 4320 | 0% |
| 8 | 8 | H first | (h + 7)*w + w*h | 184 | H first | (h + 7)*w + w*h | 184 | 0% |
| 16 | 16 | H first | (h + 7)*w + w*h | 624 | H first | (h + 7)*w + w*h | 624 | 0% |
| 32 | 32 | H first | (h + 7)*w + w*h | 2272 | H first | (h + 7)*w + w*h | 2272 | 0% |
| 64 | 64 | H first | (h + 7)*w + w*h | 8640 | H first | (h + 7)*w + w*h | 8640 | 0% |

Therefore, there is a need for a method and/or apparatus for a more efficient motion compensation.

### SUMMARY OF THE INVENTION

Embodiments of the present invention relate to a method and apparatus for motion compensation method and apparatus. The method includes retrieving data relating to a reference bock, performing a transpose on the retrieved data,performing vertical filtering on the transposed retrieved data, performing one or more transpose on the vertically filtered data, performing horizontal filtering on the transposed vertically filtered dad, and generating an interpolated bock and storing the interpolated block.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a motion compensation apparatus;

FIG. 2 is a block diagram of a digital system;

FIG. 3 is a block diagram of a video encoder;

FIG. 4 is a block diagram of a video decoder;

FIG. 5 is an embodiment of a motion compensation apparatus in accordance with the present invention; and

FIG. 6 is a flow diagram of a method for performing motion compensation in accordance with the present invention.

### DETAILED DESCRIPTION

Discussed herein are improved method and apparatus for reducing motion compensation (MC) cycles of prediction units (PU) by modifying motion compensation filtering order. For example, for prediction unit width is less than the prediction unit height, vertical filtering maybe carried out first and then horizontal filtering. The filtering order may not change for square prediction units and rectangular prediction units with prediction unit width greater than the prediction unit height. In cases, when using the modified filtering order, it has been shown that the motion compensation computation cycles reduction ranges between 5% for 64×32 block and 35% for 16×4 block, which when the motion vector is fractional in both x- and y-directions. The computation cycles for square prediction units and rectangle prediction units with prediction unit width greater than the prediction unit height may not change.

FIG. 2 is a block diagram of a digital system. FIG. 2 shows a block diagram of a digital system that includes a source digital system 200 that transmits encoded video sequences to a destination digital system 202 via a communication channel 216. The source digital system 200 includes a video capture component 204, a video encoder component 206, and a transmitter component 208. The video capture component 204 is configured to provide a video sequence to be encoded by the video encoder component 206. The video capture component 204 may be, for example, a video camera, a video archive, or a video feed from a video content provider. In some embodiments, the video capture component 204 may generate computer graphics as the video sequence, or a combination of live video, archived video, and/or computer-generated video.

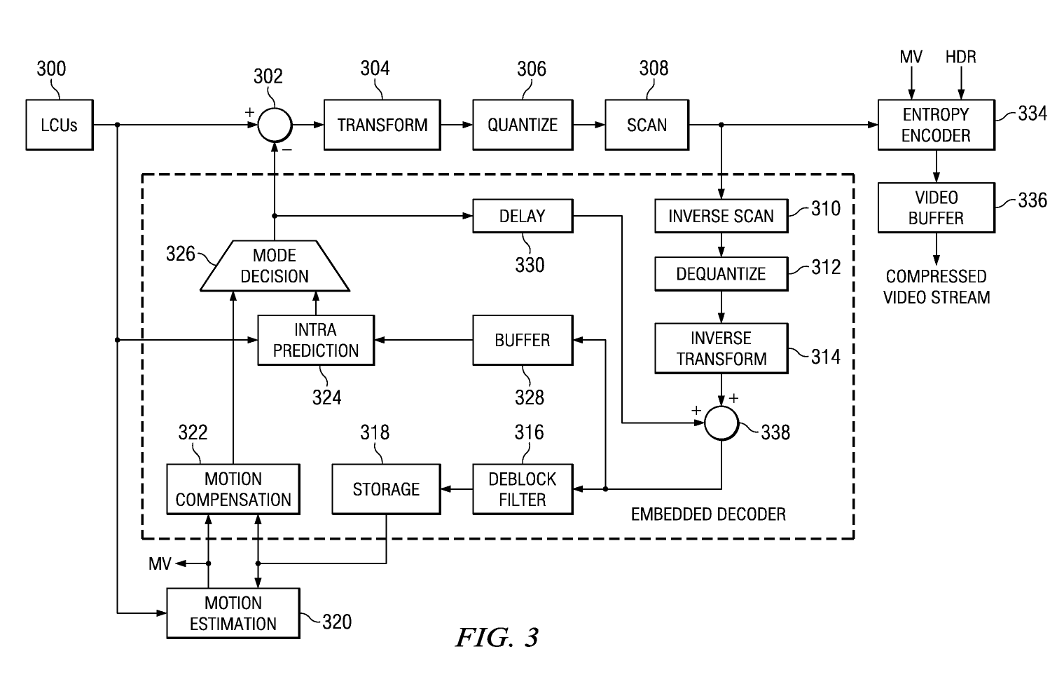

The video encoder component 206 receives a video sequence from the video capture component 204 and encodes it for transmission by the transmitter component 208. The video encoder component 206 receives the video sequence from the video capture component 204 as a sequence of pictures, divides the pictures into largest coding units (LCUs), and encodes the video data in the LCUs. An embodiment of the video encoder component 206 is described in more detail herein in reference to FIG. 3.

The transmitter component 208 transmits the encoded video data to the destination digital system 202 via the communication channel 216. The communication channel 216 may be any communication medium, or combination of communication media suitable for transmission of the encoded video sequence, such as, for example, wired or wireless communication media, a local area network, or a wide area network.

The destination digital system 202 includes a receiver component 210, a video decoder component 212 and a display component 214. The receiver component 210 receives the encoded video data from the source digital system 200 via the communication channel 216 and provides the encoded video data to the video decoder component 212 for decoding. The video decoder component 212 reverses the encoding process performed by the video encoder component 206 to reconstruct the LCUs of the video sequence.

The reconstructed video sequence is displayed on the display component 214. The display component 214 may be any suitable display device such as, for example, a plasma display, a liquid crystal display (LCD), a light emitting diode (LED) display, etc.

In some embodiments, the source digital system 200 may also include a receiver component and a video decoder component and/or the destination digital system 202 may include a transmitter component and a video encoder component for transmission of video sequences both directions for video steaming, video broadcasting, and video telephony. Further, the video encoder component 206 and the video decoder component 212 may perform encoding and decoding in accordance with one or more video compression standards. The video encoder component 206 and the video decoder component 212 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIG. 3 is a block diagram of a video encoder. FIG. 3 shows a block diagram of the LCU processing portion of an example video encoder. A coding control component (not shown) sequences the various operations of the LCU processing, i.e., the coding control component runs the main control loop for video encoding. The coding control component receives a digital video sequence and performs any processing on the input video sequence that is to be done at the picture level, such as determining the coding type (I, P, or B) of a picture based on the high level coding structure, e.g., IPPP, IBBP, hierarchical-B, and dividing a picture into LCUs for further processing. The coding control component also may determine the initial LCU CU structure for each CU and provides information regarding this initial LCU CU structure to the various components of the video encoder as needed. The coding control component also may determine the initial prediction unit and TU structure for each CU and provides information regarding this initial structure to the various components of the video encoder as needed.

The LCU processing receives LCUs of the input video sequence from the coding control component and encodes the LCUs under the control of the coding control component to generate the compressed video stream. The CUs in the CU structure of an LCU may be processed by the LCU processing in a depth-first Z-scan order. The LCUs 300 from the coding control unit are provided as one input of a motion estimation component 320, as one input of an intra-prediction component 324, and to a positive input of a combiner 302 (e.g., adder or subtractor or the like). Further, although not specifically shown, the prediction mode of each picture as selected by the coding control component is provided to a mode selector component and the entropy encoder 334.

The storage component 318 provides reference data to the motion estimation component 320 and to the motion compensation component 322. The reference data may include one or more previously encoded and decoded CUs, i.e., reconstructed CUs.

The motion estimation component 320 provides motion data information to the motion compensation component 322 and the entropy encoder 334. More specifically, the motion estimation component 320 performs tests on CUs in an LCU based on multiple inter-prediction modes (e.g., skip mode, merge mode, and normal or direct inter-prediction) and transform block sizes using reference picture data from storage 318 to choose the best motion vector(s)/prediction mode based on a rate distortion coding cost. To perform the tests, the motion estimation component 320 may begin with the CU structure provided by the coding control component. The motion estimation component 320 may divide each CU indicated in the CU structure into prediction units according to the unit sizes of prediction modes and into transform units according to the transform block sizes and calculate the coding costs for each prediction mode and transform block size for each CU. The motion estimation component 320 may also compute CU structure for the LCU and PU/TU partitioning structure for a CU of the LCU by itself.

For coding efficiency, the motion estimation component 320 may also decide to alter the CU structure by further partitioning one or more of the CUs in the CU structure. That is, when choosing the best motion vectors/prediction modes, in addition to testing with the initial CU structure, the motion estimation component 320 may also choose to divide the larger CUs in the initial CU structure into smaller CUs (within the limits of the recursive quadtree structure), and calculate coding costs at lower levels in the coding hierarchy. If the motion estimation component 320 changes the initial CU structure, the modified CU structure is communicated to other components that need the information.

The motion estimation component 320 provides the selected motion vector (MV) or vectors and the selected prediction mode for each inter-predicted prediction unit of a CU to the motion compensation component 322 and the selected motion vector (MV), reference picture index (indices), prediction direction (if any) to the entropy encoder 334

The motion compensation component 322 provides motion compensated inter-prediction information to the mode decision component 326 that includes motion compensated inter-predicted PUs, the selected inter-prediction modes for the inter-predicted PUs, and corresponding transform block sizes. The coding costs of the inter-predicted prediction units are also provided to the mode decision component 326.

The intra-prediction component 324 provides intra-prediction information to the mode decision component 326 that includes intra-predicted prediction units and the corresponding intra-prediction modes. That is, the intra-prediction component 324 performs intra-prediction in which tests based on multiple intra-prediction modes and transform unit sizes are performed on CUs in an LCU using previously encoded neighboring prediction units from the buffer 328 to choose the best intra-prediction mode for each prediction unit in the CU based on a coding cost.

To perform the tests, the intra-prediction component 324 may begin with the CU structure provided by the coding control. The intra-prediction component 324 may divide each CU indicated in the CU structure into prediction units according to the unit sizes of the intra-prediction modes and into transform units according to the transform block sizes and calculate the coding costs for each prediction mode and transform block size for each PU. For coding efficiency, the intra-prediction component 324 may also decide to alter the CU structure by further partitioning one or more of the CUs in the CU structure. That is, when choosing the best prediction modes, in addition to testing with the initial CU structure, the intra-prediction component 324 may also chose to divide the larger CUs in the initial CU structure into smaller CUs (within the limits of the recursive quadtree structure), and calculate coding costs at lower levels in the coding hierarchy. If the intra-prediction component 324 changes the initial CU structure, the modified CU structure is communicated to other components that need the information. Further, the coding costs of the intra-predicted prediction units and the associated transform block sizes are also provided to the mode decision component 326.

The mode decision component 326 selects between the motion-compensated inter-predicted prediction units from the motion compensation component 322 and the intra-predicted prediction units from the intra-prediction component 324 based on the coding costs of the prediction units and the picture prediction mode provided by the mode selector component. The decision is made at CU level. Based on the decision as to whether a CU is to be intra- or inter-coded, the intra-predicted prediction units or inter-predicted prediction units are selected, accordingly.

The output of the mode decision component 326, i.e., the predicted PU, is provided to a negative input of the combiner 302 and to a delay component 330. The associated transform block size is also provided to the transform component 304. The output of the delay component 330 is provided to another combiner (i.e., an adder) 338. The combiner 302 subtracts the predicted prediction unit from the current prediction unit to provide a residual prediction unit to the transform component 304. The resulting residual prediction unit is a set of pixel difference values that quantify differences between pixel values of the original prediction unit and the predicted PU. The residual blocks of all the prediction units of a CU form a residual CU block for the transform component 304.

The transform component 304 performs block transforms on the residual CU to convert the residual pixel values to transform coefficients and provides the transform coefficients to a quantize component 306. The transform component 304 receives the transform block sizes for the residual CU and applies transforms of the specified sizes to the CU to generate transform coefficients.

The quantize component 306 quantizes the transform coefficients based on quantization parameters (QPs) and quantization matrices provided by the coding control component and the transform sizes. The quantize component 306 may also determine the position of the last non-zero coefficient in a TU according to the scan pattern type for the TU and provide the coordinates of this position to the entropy encoder 334 for inclusion in the encoded bit stream. For example, the quantize component 306 may scan the transform coefficients according to the scan pattern type to perform the quantization, and determine the position of the last non-zero coefficient during the scanning/quantization.

The quantized transform coefficients are taken out of their scan ordering by a scan component 308 and arranged sequentially for entropy coding. The scan component 308 scans the coefficients from the highest frequency position to the lowest frequency position according to the scan pattern type for each TU. In essence, the scan component 308 scans backward through the coefficients of the transform block to serialize the coefficients for entropy coding. As was previously mentioned, a large region of a transform block in the higher frequencies is typically zero. The scan component 308 does not send such large regions of zeros in transform blocks for entropy coding. Rather, the scan component 308 starts with the highest frequency position in the transform block and scans the coefficients backward in highest to lowest frequency order until a coefficient with a non-zero value is located. Once the first coefficient with a non-zero value is located, that coefficient and all remaining coefficient values following the coefficient in the highest to lowest frequency scan order are serialized and passed to the entropy encoder 334. In some embodiments, the scan component 308 may begin scanning at the position of the last non-zero coefficient in the TU as determined by the quantize component 306, rather than at the highest frequency position.

The ordered quantized transform coefficients for a CU provided via the scan component 308 along with header information for the CU are coded by the entropy encoder 334, which provides a compressed bit stream to a video buffer 336 for transmission or storage. The header information may include the prediction mode used for the CU. The entropy encoder 334 also encodes the CU and prediction unit structure of each LCU.

The LCU processing includes an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent pictures. To determine the reconstructed input, i.e., reference data, the ordered quantized transform coefficients for a CU provided via the scan component 308 are returned to their original post-transform arrangement by an inverse scan component 310, the output of which is provided to a dequantize component 312, which outputs a reconstructed version of the transform result from the transform component 304.

The dequantized transform coefficients are provided to the inverse transform component 314, which outputs estimated residual information which represents a reconstructed version of a residual CU. The inverse transform component 314 receives the transform block size used to generate the transform coefficients and applies inverse transform(s) of the specified size to the transform coefficients to reconstruct the residual values.

The reconstructed residual CU is provided to the combiner 338. The combiner 338 adds the delayed selected CU to the reconstructed residual CU to generate an unfiltered reconstructed CU, which becomes part of reconstructed picture information. The reconstructed picture information is provided via a buffer 328 to the intra-prediction component 324 and to an in-loop filter component 316. The in-loop filter component 316 applies various filters to the reconstructed picture information to improve the reference picture used for encoding/decoding of subsequent pictures. The in-loop filter component 316 may, for example, adaptively apply low-pass filters to block boundaries according to the boundary strength to alleviate blocking artifacts causes by the block-based video coding. The filtered reference data is provided to storage component 318.

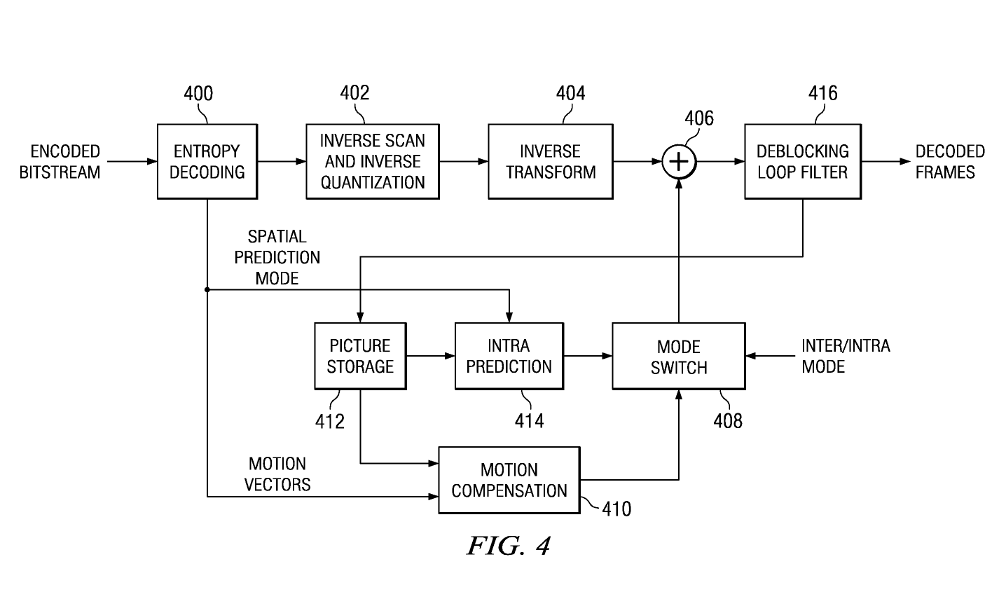

FIG. 4 shows a block diagram of an example video decoder. The video decoder operates to reverse the encoding operations, i.e., entropy coding, quantization, transformation, and prediction, performed by the video encoder of FIG. 3 to regenerate the pictures of the original video sequence. In view of the above description of a video encoder, one of ordinary skill in the art will understand the functionality of components of the video decoder without detailed explanation.

The entropy decoding component 400 receives an entropy encoded (compressed) video bit stream and reverses the entropy coding to recover the encoded PUs and header information such as the prediction modes and the encoded CU and PU structures of the LCUs. If the decoded prediction mode is an inter-prediction mode, the entropy decoder 400 then reconstructs the motion vector(s) as needed and provides the motion vector(s) to the motion compensation component 410.

The inverse scan and inverse quantization component 402 receives entropy decoded quantized transform coefficients from the entropy decoding component 400, inverse scans the coefficients to return the coefficients to their original post-transform arrangement, i.e., performs the inverse of the scan performed by the scan component 308 of the encoder to reconstruct quantized transform blocks, and de-quantizes the quantized transform coefficients. The forward scanning in the encoder is a conversion of the two dimensional (2D) quantized transform block to a one dimensional (1D) sequence; the inverse scanning performed here is a conversion of the 1D sequence to the two dimensional quantized transform block using the same scanning pattern as that used in the encoder.

The inverse transform component 404 transforms the frequency domain data from the inverse scan and inverse quantization component 402 back to the residual CU. That is, the inverse transform component 404 applies an inverse unit transform, i.e., the inverse of the unit transform used for encoding, to the de-quantized residual coefficients to produce the residual CUs.

A residual CU supplies one input of the addition component 406. The other input of the addition component 406 comes from the mode switch 408. When an inter-prediction mode is signaled in the encoded video stream, the mode switch 408 selects predicted PUs from the motion compensation component 410 and when an intra-prediction mode is signaled, the mode switch selects predicted PUs from the intra-prediction component 414.

The motion compensation component 410 receives reference data from storage 412 and applies the motion compensation computed by the encoder and transmitted in the encoded video bit stream to the reference data to generate a predicted PU. That is, the motion compensation component 410 uses the motion vector(s) from the entropy decoder 400 and the reference data to generate a predicted PU.

The intra-prediction component 414 receives reference data from previously decoded PUs of a current picture from the picture storage 412 and applies the intra-prediction computed by the encoder as signaled by the intra-prediction mode transmitted in the encoded video bit stream to the reference data to generate a predicted PU.

The addition component 406 generates a decoded CU by adding the predicted PUs selected by the mode switch 408 and the residual CU. The output of the addition component 406 supplies the input of the in-loop filter component 416. The in-loop filter component 416 performs the same filtering as the encoder. The output of the in-loop filter component 416 is the decoded pictures of the video bit stream. Further, the output of the in-loop filter component 416 is stored in storage 412 to be used as reference data.

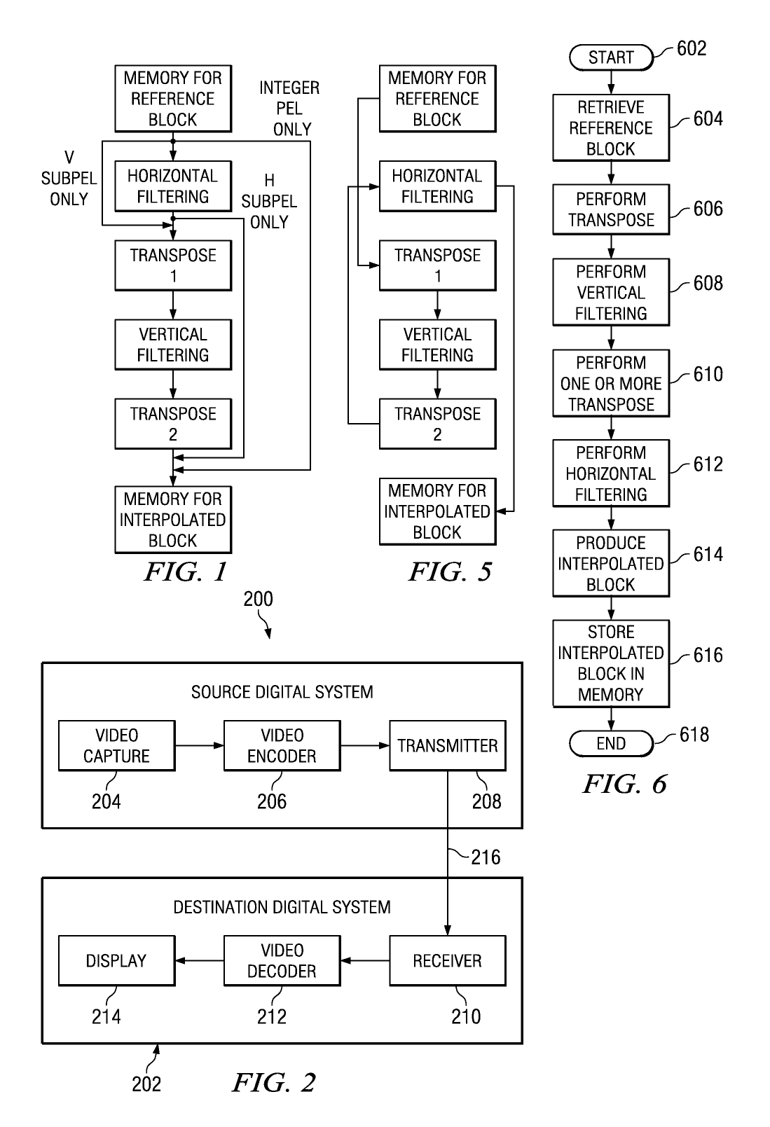

FIG. 5 is an embodiment of a motion compensation apparatus in accordance with the present invention. As shown in FIG. 5, the order to support PU size dependent MC filtering order is different from FIG. 1. Some additional Multiplexer maybe used to rewire the blocks. However, the horizontal filtering will need to support larger bit-widths. In one embodiment, for 10-bit inputs, horizontal interpolation may support 15×6 multiplication instead of 10×6 multiplication, as in HM-4.0.

In another embodiment, additional transpose operation may be introduced before the first filtering stage. Table 2 details the operation of motion compensation filtering with 3 transpose operations to support PU-size dependent motion compensation filtering order. Here the first filtering stage will still operate on data at the same bit-width. Thus, the complexity does not increase in the actual filtering blocks.

TABLE 2
Architecture 2: Supporting PU-size dependent filtering order with 3
transpose logic.

| | | | Second | |
|---|---|---|---|---|
| | | First MC filter | MC | |
| No. | Sub-Pel Options | input | filter input | Output |
| 1 | No Sub-Pel | No Transpose | No | No Transpose |
| | | | Transpose | |
| 2 | Horizontal Sub-Pel | No Transpose | No | No Transpose |
| | | | Transpose | |
| 3 | Vertical Sub-Pel | Transpose | Transpose | No Transpose |
| 4 | Sub-Pel in both | Transpose | Transpose | No Transpose |
| | directions - 2N × N, | | | |
| | 2N × N/2 case | | | |
| 5 | Sub-Pel in both | No Transpose | Transpose | Transpose |
| | directions -N × 2N, | | | |
| | N/2 × 2N case | | | |

FIG. 6 is a flow diagram of a method for performing motion compensation in accordance with the present invention. The method 600 starts at step 602 and proceeds to step 604. At step 604, the method 600 retrieves data relating to a reference bock. At step 606, the method 600 performs a transpose. At step 608, the method 600 performs vertical filtering. At step 610, the method 600 performs one or more transpose. At step 612, the method 600 performs horizontal filtering. At step 614, the method 600, as a result of the horizontal filtering, generates an interpolated bock. At step 616, the method 600 stores into memory data relating to the interpolated bock. The method 600 ends at step 618.

While the foregoing is directed to embodiments of the present invention, other and further embodiments of the invention may be devised without departing from the basic scope thereof, and the scope thereof is determined by the claims that follow.

What is claimed is:

1. A motion compensation method of a digital processor, comprising:
retrieving data relating to a reference bock;
performing a transpose on the retrieved data;
performing vertical filtering on the transposed retrieved data;
performing one or more transpose on the vertically filtered data;
performing horizontal filtering on the transposed vertically filtered data; and
generating an interpolated bock and storing the interpolated block.
